(19) United States
(12) Patent Application Publication
(10) Pub. No.: US 2008/0280677 A1
(43) Pub. Date: Nov. 13, 2008

(54) Pre-Programmed Optical Disc Designed For Secure Game Players Allowing For Pay Television Services

(75) Inventor: Robin Ross Cooper, La Mesa, CA (US)

Correspondence Address: PROCOPIO, CORY, HARGREAVES & SAVITCH LLP, 530 B STREET, SUITE 2100, SAN DIEGO, CA, 92101, US

(73) Assignee: VERIMATRIX, INC., San Diego, CA (US)

(21) Appl. No.: 12/092,816

(22) PCT Filed: Nov. 13, 2006
(86) PCT No.: PCT/US2006/060822

§ 371 Date: May 6, 2008

Related U.S. Application Data
(60) Provisional application No. 60/735,913, filed on Nov. 10, 2005.

(51) Int. Cl. G06F 17/00

(52) U.S. Cl. 463/29; 463/42; 463/43

(57) ABSTRACT

A game cartridge includes instructions designed to transform a state-of-the-art game player device into a platform for numerous pay television-related services and offerings. In one aspect the systems and methods described may include the leveraging of emerging state-of-the-art and highly secure game players to create applications targeted toward Pay Television subscribers. The system may generate a log configured to create a user profile based upon previous tendencies of the user. The log may be used to recommend offerings for products or services to the user.

### RELATED APPLICATIONS

This application claims the benefit of U.S. provisional application Ser. No. 60/735,913 filed Nov. 10, 2005.

### SUMMARY OF THE INVENTION

A game cartridge designed to transform a state-of-the-art game player device into a platform for numerous pay television-related services and offerings. In one aspect the systems and methods described herein include the leveraging of emerging state-of-the-art and highly secure game players to create applications targeted toward Pay Television subscribers. This secure platform can add benefits that will not be available on other common and well-known CE platforms for many years to come.

### BACKGROUND OF THE INVENTION

In the past, game players were as vulnerable to security breaches as current-day personal computers. The popular game players manufactured up until the year 2006 could be hacked by sophisticated pirate groups and individuals allowing for pirate copies of almost any game. Beginning in 2006, the large game manufacturing companies will begin a campaign to build game players that are fundamentally secure. As long as the software designers implement state-of-the-art policies and procedures in an effort to create a secure environment for the software code, these “Next Generation” game players can be considered secure enough to offer valuable rich media content in addition to games. Some of this rich media content can be provided by Pay-TV operators around the world.

Since the major Hollywood studios are very concerned about the security of the valuable content running on Consumer Electronic (CE) devices, using game players designed to be highly secure will provide new market opportunities to anyone embracing these platforms for the delivery of high-value content.

### BRIEF DESCRIPTION OF THE DRAWING

FIG. 1 is a representation of a game player system.

FIG. 2 is a block diagram of a system in accordance with an embodiment of the present invention.

### OVERVIEW

Most of the world's pay television is controlled and operated by large media companies including (but limited to) NBC/Universal, Newscorp, Comcast, Time Warner, and others. These large media companies control the distribution of television-based signals (analog or digital). These media companies are well positioned to create new business models that offer numerous television channels including triple-pay and even quadruple-play experiences. These new pay television based models are considered to be huge growth opportunities around the world.

With the increasing capacity of broadband around the world coupled with the increased speed and capacity of personal computers, many people are looking to monetize opportunities by delivering content over the web. To date, the efforts to obtain valuable television product (movies & TV) for web delivery have been limited. The primary reason for this limited access to content is the vulnerability of the current day PCs. PCs and other CE products are simply not robust enough to survive attacks from hackers and powerful viruses. Therefore, the owners of the world's most valuable content are not awarding high-value (early release-window) license deals to web-centric operators looking to leverage the emerging broadband market.

As the incumbents within the world of personal computing fight over philosophies relating to the content owners rights vs. the rights of private individuals, the game player manufacturers have decided to build game player devices that are secure enough to guarantee their valuable games will not be stolen quickly or easily. These efforts represent an early “win” for the gaming industry with regard to their efforts to protect their own valuable content (games). This “win” can furthermore be leveraged by other opportunities within the realm of content delivery.

The systems and methods described herein represent a highly secure method for obtaining audio-video content from multiple sources for the purpose of ultimate “play-back” on “Next Generation” game machines. Such an offering can be considered quite compelling as it represents an opportunity to prove that high-value content will always find its most secure path.

In the end, the consumer may be able to purchase game players and even the service offerings (packaged on a DVD or other long-term storage mechanism) from a retail facility and then go home to install Pay-Television services with relative ease.

The system and methods described herein can be implemented as modules running on the game player and the servers or computers and other hardware such as head ends of the described service providers

Market Differentiators

High-value content such as movies produced from Hollywood represents only a small fraction of the total content available in the world. It is well known that India, Korea, Japan, China, and other countries produce a great many more titles than those offered from Hollywood. The difference being the size of the budget and the magnitude of the overall production of these movies. To date, only Hollywood-produces movies and television have been able to satisfy consumer's desires for state-of-he-art special effects and dramatic sequences. Therefore, these large-budget movies are extremely valuable in almost all industrialized countries around the world.

In many cases, consumers are satisfied with lower-budget content as long as they feel they can gain access to the higher-budget content should they decide to pay for it. If these same subscribers feel they are being discriminated against by not being provided a facility to gain access to higher value content (even though such content is not currently being requested), then they may have a valid complaint against the Pay-TV service operator. Therefore, a Pay-TV operator who has the ability to provide a high-value Pay-TV service by way of “Next Generation” game players may be able to mitigate potential problems with subscribers who may feel compelled to complain. Such a solution can certainly be a key differentiator as new Pay-TV services proliferate.

It's only in cases where popular consumer devices become truly secure that such an attractive content offering makes good sense in the marketplace. We describe herein the other technologies, systems, methods, services, components, and solutions that are required to take a secure consumer device and turn it into a viable platform for today's pay television operators.

Specifically, it is the combination of architecturally secure and publicly available, networked consumer electronics devices (including “Next Generation” game players) coupled with International Pay-TV services that create the opportunity for high-value content delivery services that cater to the masses.

Such a system as described in this patent application can be fully digital (rather than analog) with a reasonably high-speed back channel. Such a digital network, although not novel in itself, is fundamentally more secure than an analog network, and would have fewer limitations in terms of its potential service offerings. Also, since digital delivery systems can offer a seemingly endless list of title selections, consumers in the near future can enjoy “search and play” experiences that they may have never envisioned. In contrast to legacy satellite or cable networks that are based on channels that can be tuned-in based on frequency spectrum, such a full digital network can be leveraged to provide a vastly improved service in terms of quality, capability, and selection.

Basic Operation

In the past, game players employed the use of game cartridges as the mechanism to “play” each discrete game. It is very common to see these game cartridges on the shelves of retail stores and present in other venues. In the future, these game cartridges will be replaced with high-capacity optical disc technologies such as the well known Blu-Ray and HD-DVD technologies. These high-capacity optical discs are much smaller (thinner) than the popular game cartridges, however, they contain far more capacity and are fundamentally much more secure. The preferred embodiment for this patent application uses the high-capacity optical disc technology that is now being considered for the “Next Generation” game players. This optical disc technology may deploy the use of blue or red laser technology. In fact, this patent application is agnostic of the color of the laser.

At the time of this writing, the “Next Generation” game players that will soon be available will be provided by manufacturers such as Sony with their “Playstation”, Microsoft with their Xbox series, and Nintendo. The current generation number for these game players is considered to be the third.

The consumer, after purchasing the game player, will look to see which types of games and other content offerings are readily available from the retail shelves. The technology defined within this patent application will be available and on the market shelves at some point within in the near future. Therefore, the consumer will realize that it is possible to use the game player as a platform for their own Pay Television service. This Pay Television service may be able to compliment their current television service, or it may be intended to supersede the current Pay Television services consumers may be using at the time.

By placing the optical disc containing the game player module into the game player, the consumer will be guided through an industry standard set-up menu. Once this set-up function is complete, the game player will be able to access and play television-centric content from numerous sources locally and from around the world.

The Television Service Operator

It is important to note that a Television Service Operator is required for the services defined within this patent application. In order to obtain the world's most valuable content, a robust infrastructure must be built that offers the major studios the guarantees they need to be comfortable that their content is being adequately protected and they are being paid according to the terms and conditions of all license agreements. The important thing to note is, the service operator may or may not be one of the incumbent Pay-Television service operators that exist today. In fact, the service operator may be more of a web-centric entity that is providing high-capacity bandwidth over copper wire, fiber optics, or wireless technologies. It is important to note that a service operator is required for such a service to take place and this service operator must be able to negotiate license deals with the various content owners and make this content available to the consumers of these game devices.

Note: Some Pay-TV operators offer a managed network. Such a managed network implies the service quality can be maintained at a certain performance level. Other Pay-TV operators may offer a “best efforts” network solution. This means they have no absolute control over the network's performance, however, they will try their best to maintain a high quality experience for the consumer. The preferred embodiment for this patent application is the Pay-TV operator who offers a managed network.

Methods to Consume Content

Given such a game player and its ability to secure high-value content, it is possible for the following methods to consume the content:
Download uncompressed audio-video data
Download compressed audio-video data
Stream uncompressed audio-video data
Stream compressed audio-video data
Download to writeable storage media
Stream to writeable storage media
Other methods to transport content

At the time of this writing, the preferred compressed formats are primarily VC1, MPEG-2, and MPEG-4. It is possible for other compression formats to be used as well.

Overview of the Service Offering

Since such an offering serves to protect the valuable content while providing consumers with the widest range of service offerings, very large scale applications can be developed (around this game player paradigm) such as:
International Television Aggregation (defined below)
Web Television Aggregation (defined below)
Multi-level Electronic Program Guide (EPG—defined below)
Client-side Personal Video Recorder (PVR)
Server-side Personal Video Recorder
Video-On-Demand (VOD)
Pay-Per-View (PPV)
Content suggestions based on recognized profiles (defined below)
Target advertising based on recognized profiles (defined below)
Other offerings.

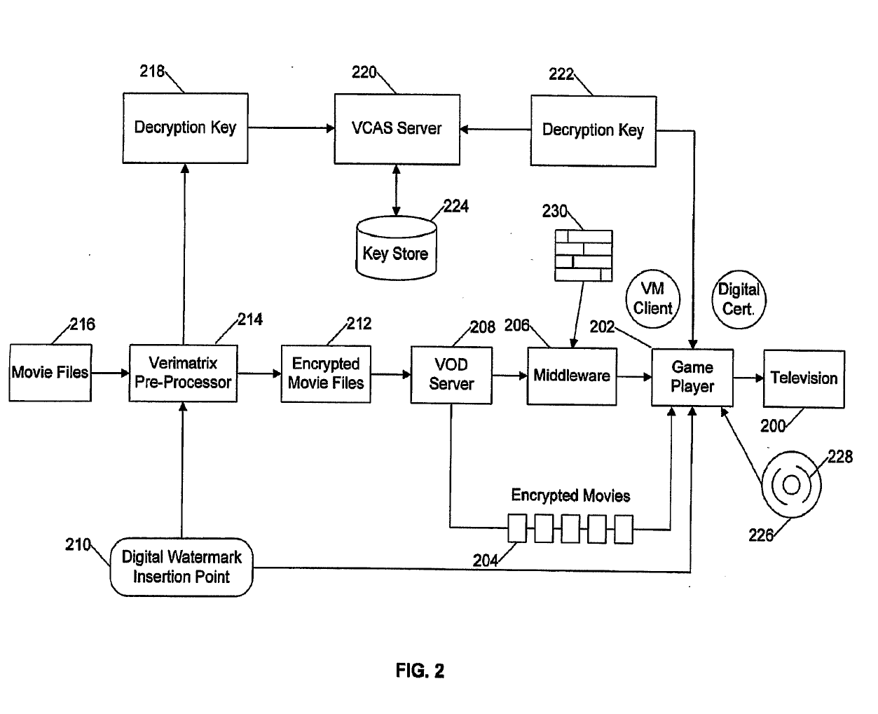

Description of FIG. 2:

FIG. 2 shows one embodiment of the present invention. FIG. 2 includes files 216, a pre-processor 214, encrypted files 212, a VOD/game server 208, a middleware layer 206, an EPG 230, key store 224, an encryption key 218, a VCAS server 220, a decryption key 222, a game player 202, an encrypted file route 204, a watermarking block 210, and a television 200.

In operation, the game player 202 may be used to play games or to receive video content via instructions 228. Instructions 228 are shown as residing on the optical disc 226 although this is not necessary. Instructions 228 may reside anywhere that is accessible to the game player 202. For example, a conventional web browser may be used to access the instructions on a remote server or at an FTP site. Similarly, the game player 202 may include an internal or external memory such as a random access memory (RAM), read only memory (ROM), flash memory, a hard drive, and the like.

The results and/or output are presented on television 200 for viewing by a user. Files 216 maybe for example movie files and/or game files. The files 216 may be delivered to the game player 202 via the pre-processor 214, which may use the watermarking block 210 and may also encrypt the files 216. Thereafter, the encrypted movie and/or game files 212 are delivered to the VOD/game server 208 which transfers the encrypted files 212 either along the encrypted file route 204 or to the middleware layer 206. After passing along the encrypted file route 204 or through the middleware layer 206, the encrypted files 212 arrive at the game player 202 for use by the user, either to play a game or watch video content, for example.

VCAS server 220 may use the encryption key 218, the decryption key 222, and/or the key store 224 to generate the encrypted files 212. The EPG 230 may reside in the middleware layer 206 and may be used for example, by a user of the game player 202 to request more information about one or more of the files 216 or to browse through the files 216 to determine which file the user wants to access.

How It Works—The Initial Set-Up Menu

After connecting the game player 202 to the television 200, the consumer will be able to insert the optical disc 226 to set-up the pay television service. The instructions 228 or software on the optical disc 226 cause the game player 202 to perform the functions described herein. An example of the basic information required for the initial set-up function is as follows:
Name
Address
City, State, Zip
Phone number(s)
Email Address(es)
Number of people in household (or business)
First names of people in household (or business)
Age ranges of people in household (or business)
Name of Broadband Provider
Name of the selected Pay-TV Service Operator
Other information.
Note: It is possible that each Pay-TV Service Operator may have a discrete optical disc that is dedicated to its own particular Pay-TV service offering. In an alternative embodiment, a single optical disc may offer multiple Pay-TV services.

Once this information is entered into the game player 202, the game player 202 will attempt to connect to the consumer's choice of Pay-TV services. If a connection cannot be established, the Set-up menu will continue to assist the consumer as necessary.

Set-Up Procedure Initiated by the Selected Pay-TV Service Operator

Once the selected Pay-TV Service Operator gains control (after the initial set-up routines are completed), the Pay-TV Service Operator will query for two primary pieces of information as follows:
Method of Billing
Verification of Identity (or other form of authentication)
Verification of Entitlements.
Note: The Pay-TV Service Operator may wish to query for a number of additional data points from the consumer. The two single most important data points, however, are the items listed above.

Method of Billing

The method of billing may be one or more of the options listed below:
Monthly bill mailed to residence or business
Credit Card Payment
Internet Payment Mechanism (such as PayPal or others)
Automated Bank Debit
Pre-Payment of Services
Other payment methods.

Apportionment

A critical counter-part to the billing function is the apportionment function. The apportionment function should separate the monies owed to all individuals involved in the content distribution supply chain. It is envisioned that such a service as defined in this patent application will be carried-out by the service operator, however, other scenarios can exist as well.

Verification of Identity

The Pay-TV service operator will need to verify the identity of the new subscriber. As it is relatively easy to provide a false identity on-line, the service operator should use state-of-the art means to link the new subscriber to a known individual. The preferred embodiment for such identity verification is called “Federated Authentication” which is a patent pending technology created by Verimatrix, Inc., of San Diego, Calif. Federated Authentication links the new subscriber to the physical address of the home or building where he (or she) is currently residing. This “liking” function can be facilitated by the local telephone company that can offer this form of authentication as a utility to the consumer. More information about Federated Authentication can be learned by reading the provisional patent applications filed by Verimatrix, Inc.

Other forms of authentication or identity verification can be used as well. Some of the acceptable forms may be (but are not limited to):
Successful questionnaires offered by credit agencies such as Equifax and Experion.
Personal interview by service operator personnel
Validly issued hardware devices such as smartcards, dongles, or other security mechanisms designed for consumers.
Other means (on-line or off-line) to effectively authenticate a new subscriber's identity.

Verification of Entitlements

After the billing arrangements have been verified and the consumer has been authenticated, then it will be important to verify the consumer's entitlements for the service. Entitlements meaning which assets are available to the consumer. Assets can be (but are not limited to) the following:
Television shows
Television channels
Pay-Per View shows
Pay-Per View channels
Video-on-Demand shows
Other offerings of valuable rich media assets.

The Middleware

A Middleware layer 206 is important to help guide the new subscriber through the various offerings including walled-garden applications. This Middleware function can either be provided on the optical disc 226, or it can alternatively be provided by way of a code download to the game box from the service operator.

Security

Campbell, Richard E. It is certainly comforting for content owners to know that a consumer electronic device such as the game player 202 is fundamentally secure by way of its architecture. This fact could be meaningless, however, if the entire network environment is not equally secure. It's only when the player device and the network are both highly secure that the high-profile content owners will agree to supply their content to these devices and service offerings. Below is a list of security technologies that will be deployed in a preferred embodiment:

The Headend

The headend equipment will include mechanisms to either pre-encrypt the content or, in the case of real-time broadcast feeds, encrypt the content in real-time. In a preferred embodiment, the encryption algorithms being deployed will be based on standards such as AES-128. Upon encryption, the headend equipment will communicate with a Key-Server 220 that will be used to securely pass the necessary encryption keys (in-band or out-of-band) to the approved devices.

The Network

The network itself should be configured in such a way that a virtual private network (VPN) or similar can be established. It is important that an unauthorized device not be able to log on or establish communication in any way.

The Environment

The server-side environment should be fundamentally secure and should include polices and procedures for personnel associated with the service to follow. For example, personnel should know the following and more:
How to securely compile software code
How to securely make code available to the game players
How to physically secure all network systems and components
How to physically secure all facilities used to house headend equipment.

Digital Rights Management

A Digital Rights Management (DRM) system should be employed that will manage the encrypted data along with the encryption keys that are used to encrypt and decrypt the data. In addition, the DRM system will take steps to:
Authenticate client devices
Check for the existence of clone devices
Authenticate devices that are local to the authenticated target device
Check for parameters such as:
   Authorized number of plays
   Start and end time for authorized play
   Other authorization parameters and entitlements.

Note: A DRM system can provide a number of other security functions and services as well.

Server-Side Watermarking

Such a network that offers valuable content to game player devices should have the ability to place a robust and survivable video (and/or audio) watermark into the content before it is transmitted to the target device, for example in watermarking block 210. Such a watermark indicates where the content originated. For an example, such a server-side watermark in watermarking block 210 can indicate the source of the content and the date and time when it was received by the service operator. This server-side watermark coupled with the session-based watermark (described below) both provide a reasonable history of the movement of the content information from the time it was transported from the source until the time it was received by the service operator.

Session-Based Watermarking

The session-based watermark is also a robust and survivable video (and/or audio) watermark, however, it is applied to the content in real-time as it is being exhibited to the consumer. Such a session-based watermark serves the purpose of determining the identity of the consumer should the consumer decide to become involved in acts of digital looting or piracy. Such session-based watermarks are particularly useful in the following scenarios:
Attempts to steal content from a display screen
Attempts to steal content from a screen within a theater
Attempts to steal content from a hard disc drive or other storage medium
Attempts to capture image information from a display buffer (or filter)
Other such attempts.

Broadcast Flag

The Broadcast Flag is a small flag that can be placed in either an analog television signal or within the broadcast of digital information. The purpose of the Broadcast Flag is to indicate that the content is not allowed to be “re-broadcast” anywhere else.

In the case of an analog television signal, the Broadcast Flag is placed within the Line 21 data. Within a Digital Broadcast, the Broadcast Flag is placed either in the Program Management Table (PMT) or the Master Guide Table (MGT).

In the case of a consumer that wishes to “re-broadcast” to one of his (or her) own localized device, the content should be encrypted before it can be “re-broadcast”.

In a preferred embodiment, the game player devices as described in this patent application will respect the Broadcast Flag and obey its rules.

Sequence Trees

Sequence Trees are used to add, renew, and revoke devices that can be used externally to the game player. Sequence Trees, similar to binary trees, are files of data used to locate devices that are found to be engaged in acts of digital looting and/or piracy. When a device is found to be a tool used to pirate the content from such a system as described above, the Tree is updated with the information about the specific device found to be the culprit. Once this updated tree is loaded into the game player device, the external device will no longer be available to the game player. Only when the manufacturer of the device can prove that the threats of piracy have been mitigated can the Sequence Trees be updated in such a way to allow the use of such an external device once again.

Likewise, Sequence Trees can be used to approve devices and even renew devices that have been modified (even the game player itself) so these devices can no longer engage in acts of digital looting and piracy.

Transcoding

In a preferred embodiment, either the server-side of the network or the game player itself will be able to transcode the content coming in for proper encoding and for the optimized “fit” on the screen.

Game Player as a Home Media Center

In an alternative embodiment, the game player 202 can be used as a Home Media Center. This capability will allow the Game Player 202 to connect to multiple input sources thereby allowing the consumer to select the desired “play back” experience. These “play back” experiences may be through the following means:
POTs lines within a home or office
Ethernet (or other high-speed) connectivity solutions
Fiber Optics
Coaxial cable within a home or office (MOCA)
Wireless networking technologies.

Game Player as a Digital Media Adapter

In an alternative embodiment, the game player 202 can also be used as a Digital Media Adapter (DMA). The DMA enables remote devices to connect to the game player 202 (or other Home Media Center) remotely.

Multi-Rights

In a preferred embodiment, either the server-side of the network or the game player 202 itself will be able to employ a digital rights management (DRM) scheme that is appropriate for the ultimate client device. In some cases this means the system will need to decrypt the content and then again re-encrypt the content adding the appropriate DRM parameters. In other cases, the system may only need to encrypt and add the appropriate DRM parameters once.

Re-Flashing Game Box

Another tool to reduce acts of piracy is to allow some or all of the game device's operating system to be updated byway of “re-flashing” its long-term memory. This is typically a function that is managed carefully by the Game Box manufacturer.

Content Registry

A Content Registry can also be used as an effective counter-measure for revoking devices that are known to be engaged in acts of digital looting and/or piracy. Such a Content Registry may have fields such as:
Content Identifier
Server-side watermark ID
Edge-site watermark ID
Session-based watermark ID 1
Session-based watermark ID 2
Session-based watermark ID 3
Session-based watermark ID 4
Device ID
Service Operator ID
Subscriber ID
Other identifiers.

Once content is found in an unauthorized location, it is possible to check the Content Registry in order to determine how the content was released from its secured environment. If it determined that an external device was used to pirate the content, then such an external device will be added to the Sequence Trees (described above) so such device will no longer be effective in acts of digital piracy.

Note: Other determinations can also be made with regard to how best protect the content from further attacks.

Other Security Means and Mechanisms

It is possible that additional security technologies can be deployed in addition to the technologies described above. Some of these additional security technologies may involve one or more of the following:
Biometrics
Cameras (possibly for security purposes)
Smart Cards
Other external devices containing keys or secrets
Still other security means and/or mechanisms.

International Television Searching

Once such a system exists as is described in this patent application, it will be possible for the Service Operator to allow a subscriber to view all types of content from around the world. Given a robust middleware layer 206 and an EPG 230, the subscriber will be able to see a virtual number of content selections. It is envisioned that the middleware layer 206 and Electronic Program Guides will be designed in such a way as to allow for a user-friendly Television searching experience.

International Television Aggregation

Given the nature of both the secure game player and the Pay-TV service as described in this patent application, it is possible for the service operator to aggregate, edit, and appropriately redistribute the content in such a way as to make it a rewarding experience for subscribers and content owners alike. Noted in the patent application is the reference to a patent application owned by Verimatrix, Inc. named International Television Aggregation. This patent application anticipates the availability and use of the International Television Aggregation patent application for use with next generation game machines.

Web Television Aggregation

In addition to the specifications and figure provided within this patent application regarding International Television Aggregation, it is also possible to aggregate audio-video content from web-based sources as well.

Multi-Level Electronic Program Guide

Within a Pay-Television service with a virtually unlimited number of content selections, a multi-level EPG 230 is highly recommended. Such an EPG 230 will need to allow a subscriber to navigate to virtually any single piece of content with a minimum amount of effort. An example of such a Multi-level EPG 230 is one that provides the subscriber with a list of major categories. After the subscriber makes an initial selection, more sub-categories are presented. Finally, a list of individual content selections is made available to the subscriber.

Profiling Subscriber for Content Recommendations

As subscribers use such a system as described in this patent application, it will be possible to log the various activities of the subscriber in an effort to identify certain tendencies. In some cases, it may be possible to determine a certain user-profile. Once these tendencies are determined, it will be possible to make appropriate recommendations for content that's available from the service operator.

Profiling Subscriber for Offerings, Gifts, and Coupons

After collecting usage information and determining tendencies, it is possible to create a user profile for the purposes of providing valuable product or service offerings to the subscriber. Such an offering can serve to encourage the subscriber to continue using the service while introducing the subscriber to potentially new products, services, and offerings from vendors. Offerings can include (but are not limited to):
Gifts
Coupons
Extra Content “plays”
Other value offerings.

Profiling to Create Communities

In a preferred embodiment, the profiles created and collected from such an offering as described above can be used to create “Communities”. These “Communities” can be used to segregate groups of people based on their preferences and inclinations. Such “Communities” can be used to add further enjoyment and relevance to the consumer.

Extended Television Service Offerings

The information provided in the patent application up until this point describes how to build an environment around an architecturally secure game player to allow high-value Pay-Television services. The significant differentiators being:
Game machine sales are significant around the world and the populations of people who engage in playing games are increasing as a result of many new mobile devices (and offering games). Unlike a set-top-box that can only assist the television operator in delivering television-based services, the game machine can act as a stand-alone, independent device that is fully enabled to perform virtually all set-top-box-related functions as well.

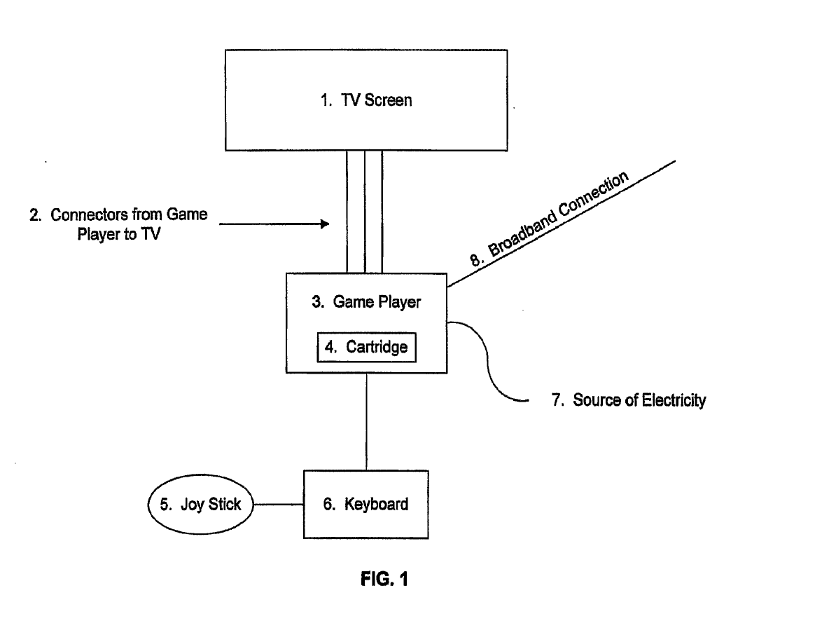

Description of FIG. 1:

FIG. 1 shows a Game Player connected a TV screen (1). The connectors (2) are shown between the TV screen (1) and the Game Player device (3). The game player comes configured with an Optical Disc drive (4). A Joy Stick (5) and a Keyboard (6) are both typical add-ons for such a popular game player (3). The source of electricity is also displayed (7). Finally, the broadband connection (8).

Those of skill in the art will appreciate that the various illustrative modules, engines, and method steps described in connection with the embodiments disclosed herein can often be implemented as electronic hardware, software, firmware or combinations of the foregoing. To clearly illustrate this interchangeability of hardware and software, various illustrative modules and method steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module or step is for ease of description. Specific functions can be moved from one module or step to another without departing from the invention.

Moreover, the various illustrative modules, engines, and method steps described in connection with the embodiments disclosed herein can be implemented or performed with a general purpose processor, a digital signal processor (“DSP”), an application specific integrated circuit (“ASIC”), field programmable gate array (“FPGA”) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent exemplary embodiments of the invention and are therefore representative of the subject matter which is broadly contemplated by the present invention. It is further understood that the scope of the present invention fully encompasses other embodiments and that the scope of the present invention is accordingly limited by nothing other than the appended claims.

1.-18. (canceled)

19. A method for providing video content through a game player, comprising:
requesting input of set-up information by a user on a game player, the set-up information comprising at least user identifying information and the name of at least one selected video content service provider;
receiving the requested set-up information from the user at the game player;
establishing a connection between the game player and the selected video content service provider over a network;
receiving a query from the video content service provider requesting user identifying information;
providing the requested user identifying information from the game player to the video content service provider;
receiving a request for video content from the user at the game player;
forwarding the request for video content from the game player to the content service provider;
adding a security feature to the requested video content;
providing the content with the security feature to the game player; and
playing the video content on a video output device associated with the game player for viewing by the user.

20. The method of claim 19, wherein the set-up information requested from the user further comprises the name of a broadband provider.

21. The method of claim 19, wherein the set-up information requested from the user further comprises user billing information.

22. The method of claim 19, wherein the set-up information requested from the user further comprises the number and age ranges of people in the household or business using the game player.

23. The method of claim 19, wherein the content service provider is a pay-per-view or a pay television (TV) service provider.

24. The method of claim 19, further comprising verifying the identity of a new user after connection is established between the game player and content service provider.

25. The method of claim 19, further comprising storing set-up instructions for at least one predetermined content service provider on a storage medium, installing the storage medium on the game player, and using the stored set-up instructions to request set-up information from the user and to establish a connection with the content service provider.

26. The method of claim 25, wherein the storage medium is an optical disc.

27. The method of claim 19, wherein the step of adding a security feature comprises adding a watermark to the video content.

28. The method of claim 27, wherein the step of adding a security feature further comprises encrypting the video content.

29. The method of claim 28, further comprising receiving instructions at the game player for decrypting received video content prior to playing back the decrypted video content on the video output device.

30. The method of claim 27, wherein the step of adding a security feature further comprises applying one or more digital rights management technologies to the video content.

31. The method of claim 27, wherein the step of adding a security feature further comprises adding a broadcast flag to the video content.

32. The method of claim 19, wherein the step of receiving a request for video content at the game player comprises receiving a selection made by the user from an electronic program guide (EPG) which lists the content available from the video content service provider.

33. The method of claim 19, further comprising the steps of providing a sequence tree in the game player, using the sequence tree to locate a device external to the game player that is unauthorized, updating the sequence tree to disable the unauthorized device, and enabling the device if the device becomes authorized.

34. The method of claim 19, wherein the step of modifying the game player further comprises generating a log configured to store information on usage of the game player by the user.

35. The method of claim 34, further comprising collecting information on usage of the game player by the user, storing the information in the log, and determining a user profile based on the information collected in the log.

36. The method of claim 35, further comprising making recommendations for content available from the service provider to a user of the game player based on the user profile.

37. The method of claim 35, further comprising offering a product or service to a user of the game player based on information in the user profile.

38. A content distribution system, comprising:
a game player;
a storage module accessible to the game player containing initialization instructions which initialize the game player to receive video content from a video content service provider over a network, and to play the received video content for viewing by a user, the initialization instructions including instructions for requesting input information from a user of the game player, the input information comprising at least user identification information;
a communication module which links the initialized game player to the video content service provider over at least one network and provides user identification information and video content requests from the game player to the service provider; and
a security module which adds at least one security feature to the requested video content and forwards the secured video content to the initialized game player for viewing by the user.

39. The system of claim 38, wherein the storage module is an optical disc and the game player has an optical disc drive.

40. The system of claim 38, wherein the storage module is located at a remote server accessible by the game player over a network.

41. The system of claim 38, wherein the storage module is a memory device associated with the game player.

42. The system of claim 38, further comprising an electronic program guide (EPG) associated with the game player, the EPG listing video content available from the video content service provider and having an input which allows a user to select programs from the EPG.

43. The system of claim 42, further comprising a middleware layer linked with the game player, the EPG residing in the middleware layer.

44. The system of claim 38, further comprising a log stored by the initialized game player which collects usage information and creates a user profile based on the collected usage information.

45. The system of claim 38, wherein the security module comprises an encryption module which encrypts the requested video content.

46. The system of claim 38, wherein the security module comprises a digital watermark insertion module.

47. The system of claim 45, further comprising a decryption module associated with the game player which adapts the game player to decrypt the received video content for playback on a video output device.

48. A game player device, comprising:
a game player module which allows a user to play games;
a first connection which links the game player device to an output viewing device;
an initialization module which contains initialization instructions for initializing the game player module to establish a link to one or more video content service providers over a network and to receive video content over the link for playback on an output viewing device associated with the game player device, the initialization instructions including instructions for requesting input information from a user of the game player, the input information comprising at least user identification information; and
a second connection which links the game player module to at least one video content service provider after initialization is complete;
whereby the initialized game player device forwards user identification information and user requests for video content to the service provider and receives requested video content for viewing by the user as an alternative to playing games.
